(19) United States
(12) Patent Application Publication
(10) Pub. No.: US 2013/0166805 A1
(43) Pub. Date: Jun. 27, 2013

(54) INTERRUPT CAUSE MANAGEMENT DEVICE AND INTERRUPT PROCESSING SYSTEM

(71) Applicant: Daisuke Osagawa, Tokyo (JP)

(72) Inventor: Daisuke Osagawa, Tokyo (JP)

(73) Assignee: Mitsubishi Electric Corporation, Tokyo (JP)

(21) Appl. No.: 13/819,404

(22) PCT Filed: Dec. 14, 2010
(86) PCT No.: PCT/JP10/72479

§ 371 Date: Feb. 27, 2013

(51) Int. Cl. G06F 13/24

(52) U.S. Cl. CPC G06F 13/24
USPC 710/267

(57) ABSTRACT

A peripheral device sends an interrupt generation notification to a bus bridge. The bus bridge receives the interrupt generation notification, transfers the received interrupt generation notification to a CPU, reads an interrupt cause from the peripheral device that has sent the interrupt generation notification, and writes to a memory the interrupt cause that has been read. Upon receiving the interrupt generation notification, the CPU reads the interrupt cause from the memory which allows fast access, and begins interrupt processing corresponding to the interrupt cause. Interrupt processing time up to commencement of the interrupt processing can be reduced.

### TECHNICAL FIELD

This invention relates to interrupt processing in a computer.

### BACKGROUND ART

In interrupt processing in a computer, in order to make a CPU (Central

Processing Unit) respond promptly to an interrupt from a peripheral device, it is required to reduce interrupt processing time from an interrupt generation notification by a peripheral device up to commencement of processing for each interrupt cause by the CPU.

Patent Document 1, for example, discusses a technology to reduce interrupt processing time in an interrupt processing method in which a peripheral device and a CPU are connected via a bus bridge, and notification of generation of an interrupt is performed separately from notification (or read) of an interrupt cause.

In the interrupt processing method of Patent Document 1, the bus bridge receives an interrupt generation notification sent from the peripheral device, and transfers the interrupt generation notification to the CPU. At the same time, the bus bridge reads an interrupt cause from the peripheral device, and stores in the bus bridge the interrupt cause that has been read.

By this arrangement, the CPU can read the interrupt cause from the bus bridge to which the CPU can access faster than to the peripheral device, so that the interrupt processing time can be reduced.

FIG. 4 shows the interrupt processing time when the bus bridge completes reading the interrupt cause from the peripheral device before the CPU begins to read the interrupt cause from the bus bridge.

### Citation List

### Patent Document

Patent Document 1: JP 2006-236234 A

### DISCLOSURE OF INVENTION

### Technical Problem

In the interrupt processing method of Patent Document 1, there is a problem. The problem is that, as shown in FIG. 4, an access from the CPU to the bus bridge is slow, so that it takes time for the CPU to read the interrupt cause.

One of the primary objects of the present invention is to solve the above-described problem. The present invention primarily aims to reduce time it takes for the CPU to read the interrupt cause and to reduce interrupt processing time.

### Solution to Problem

An interrupt cause management device according to the present invention includes:

an interrupt generation notification receiving unit that receives an interrupt generation notification sent from a device;

an interrupt cause reading unit that, when the interrupt generation notification is received by the interrupt generation notification receiving unit, reads an interrupt cause from the device that has sent the interrupt generation notification; and an interrupt cause writing unit that writes the interrupt cause read by the interrupt cause reading unit to a memory device to be accessed by a processor device that processes the interrupt generation notification.

### Advantageous Effects of Invention

According to the present invention, an interrupt cause is read from a device that has sent an interrupt generation notification, and the interrupt cause that has been read is written to a memory device to be accessed by a processor device.

Therefore, the processor device can read the interrupt cause from the memory device which allows fast access, so that interrupt processing time can be reduced.

### BRIEF DESCRIPTION OF DRAWINGS

FIG. 1 is a diagram showing an example of a configuration of an interrupt processing system according to a first embodiment;

FIG. 2 is a diagram showing an example of a configuration of a bus bridge according to the first embodiment;

FIG. 3 is a diagram illustrating interrupt processing time according to the first embodiment; and

FIG. 4 is a diagram illustrating interrupt processing time according to existing art.

### DESCRIPTION OF PREFERRED EMBODIMENTS

### First Embodiment

In this embodiment, description will be directed to a configuration that reduces interrupt processing time in an interrupt processing method in which a peripheral device and a CPU are connected via a bus bridge, and notification of generation of an interrupt is performed separately from notification (or read) of an interrupt cause.

More specifically, in this embodiment, the bus bridge reads an interrupt cause from a peripheral device and writes the interrupt cause to a memory which is an external device allowing fastest access from the CPU. By this arrangement, an amount of time required by the CPU to read the interrupt cause is reduced, thereby reducing the interrupt processing time.

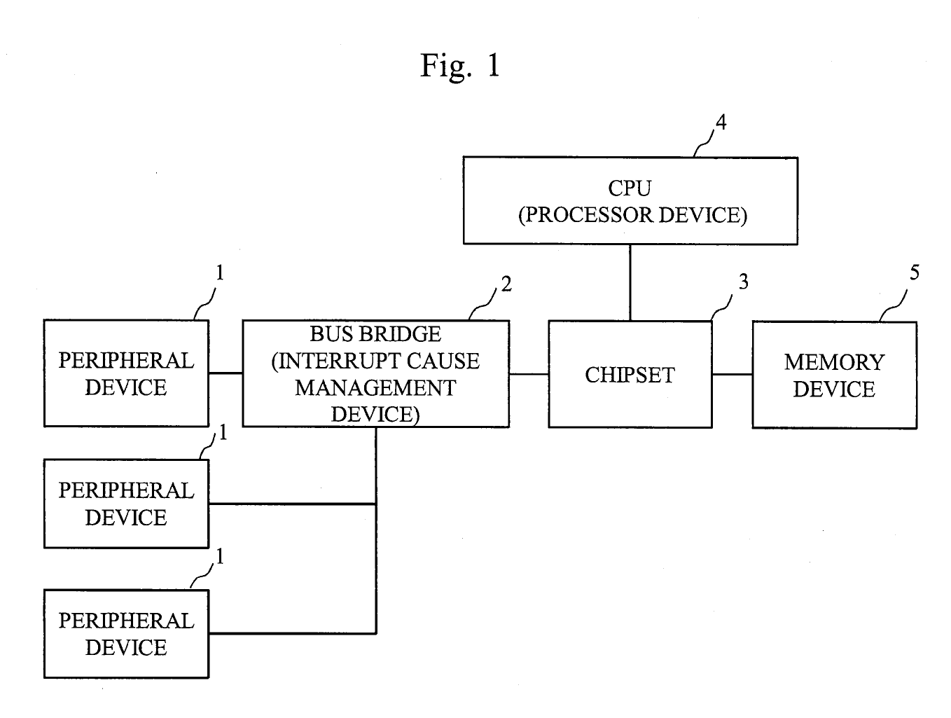

FIG. 1 shows an example of a configuration of an interrupt processing system according to this embodiment.

In FIG. 1, a peripheral device 1 sends an interrupt generation notification and stores an interrupt cause.

A bus bridge 2 transfers the interrupt generation notification and the interrupt cause.

The bus bridge 2 is an example of an interrupt cause management device.

A chipset 3 acts as an intermediary for communications among the bus bridge 2, a CPU 4, and a memory 5.

The CPU 4 which is a processor device receives the interrupt generation notification, reads the interrupt cause, and executes processing for each interrupt cause. The memory device 5 (also to be described as the memory 5) stores the interrupt cause written by the bus bridge 2.

In this interrupt processing system, the CPU 4 has faster access to the memory 5 than to the bus bridge 2.

The CPU 4 and the bus bridge 2 respectively have access to the memory 5.

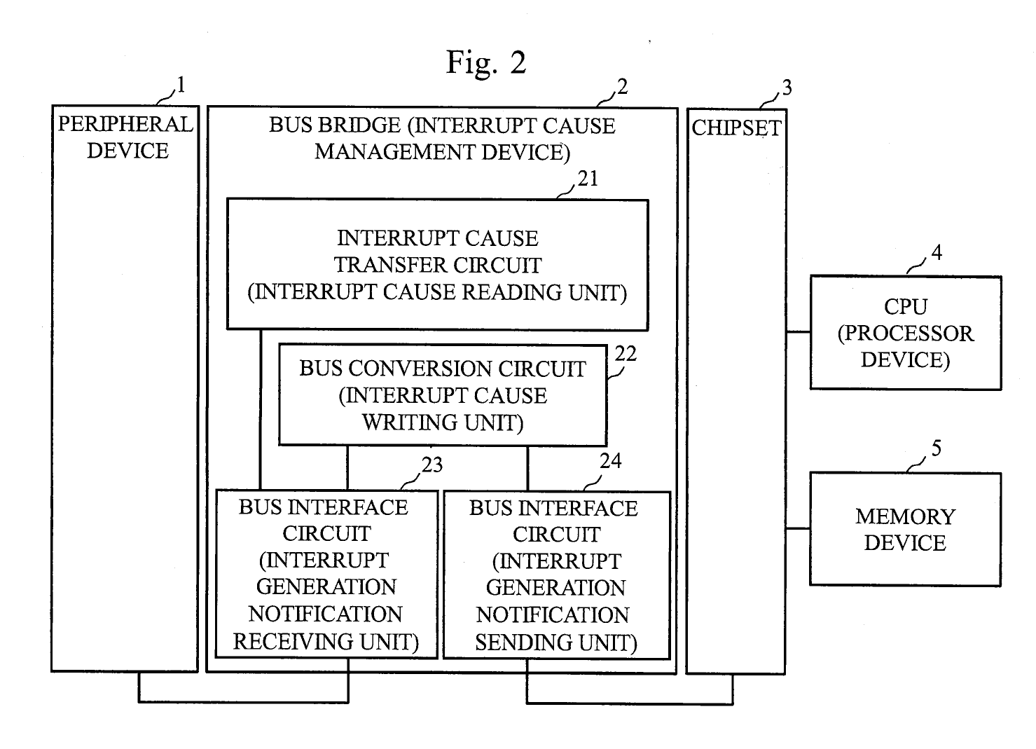

FIG. 2 shows an example of a configuration of the bus bridge 2 according to this embodiment.

In FIG. 2, a bus I/F (interface) circuit 23 receives an interrupt generation notification sent from one of the peripheral devices 1.

The bus interface circuit 23 is an example of an interrupt generation notification receiving unit.

A bus interface circuit 24 sends to the CPU 4 via the chipset 3 the interrupt generation notification received by the bus interface circuit 23.

The bus interface circuit 24 is an example of an interrupt generation notification sending unit.

When the interrupt generation notification is received by the bus interface circuit 23, an interrupt cause transfer circuit 21 reads an interrupt cause from the peripheral device 1 that has sent the interrupt generation notification.

The interrupt cause transfer circuit 21 is an example of an interrupt cause reading unit.

A bus conversion circuit 22 converts communications between the peripheral device 1 and the chipset 3.

The bus conversion circuit 22 also writes the interrupt cause read by the interrupt cause transfer circuit 21 to the memory 5 to be accessed by the CPU 4.

The bus conversion circuit 22 is an example of an interrupt cause writing unit.

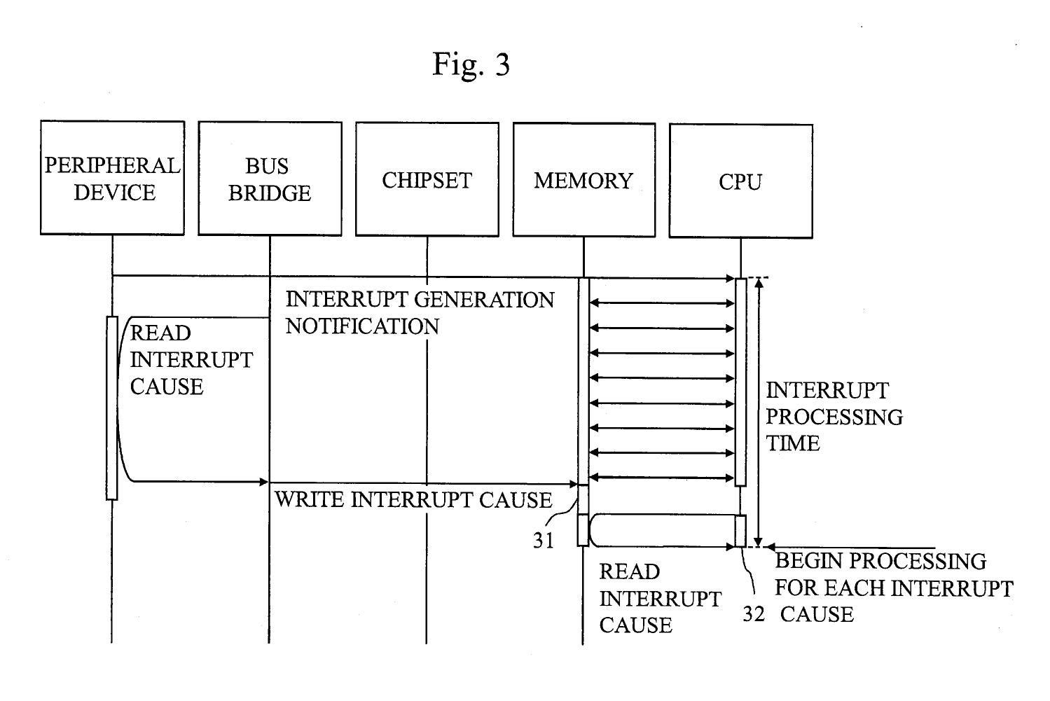

Referring to FIGS. 2 and 3, operations in the interrupt processing system according to this embodiment will now be described.

First, the peripheral device 1 sends to the bus bridge 2 the interrupt generation notification for notifying generation of an interrupt.

In the bus bridge 2, the bus interface circuit 23 receives the interrupt generation notification, and transfers the received interrupt generation notification to the interrupt cause transfer circuit 21 and the bus conversion circuit 22.

The bus conversion circuit 22 sends the received interrupt generation notification to the CPU 4 via the bus interface circuit 24 and the chipset 3.

Based on the interrupt generation notification, the CPU 4 begins interrupt processing.

On the other hand, upon receiving the interrupt generation notification, the interrupt cause transfer circuit 21 reads an interrupt cause from the peripheral device 1 via the bus interface circuit 23.

The interrupt cause transfer circuit 21 can identify from the interrupt generation notification the peripheral device 1 that has sent the interrupt generation notification.

The received interrupt cause is transferred to the bus conversion circuit 22 by the bus interface circuit 23. The bus conversion circuit 22 writes the interrupt cause to the memory 5 via the bus interface circuit 24 and the chipset 3.

The CPU 4 reads the interrupt cause written to the memory 5 before beginning processing for each interrupt cause.

As shown in FIG. 3, after reading the interrupt cause, the bus conversion circuit 22 writes the interrupt cause to the memory 5 before a timing when the CPU 4, upon receiving the interrupt generation notification, accesses the memory 5 to read the interrupt cause.

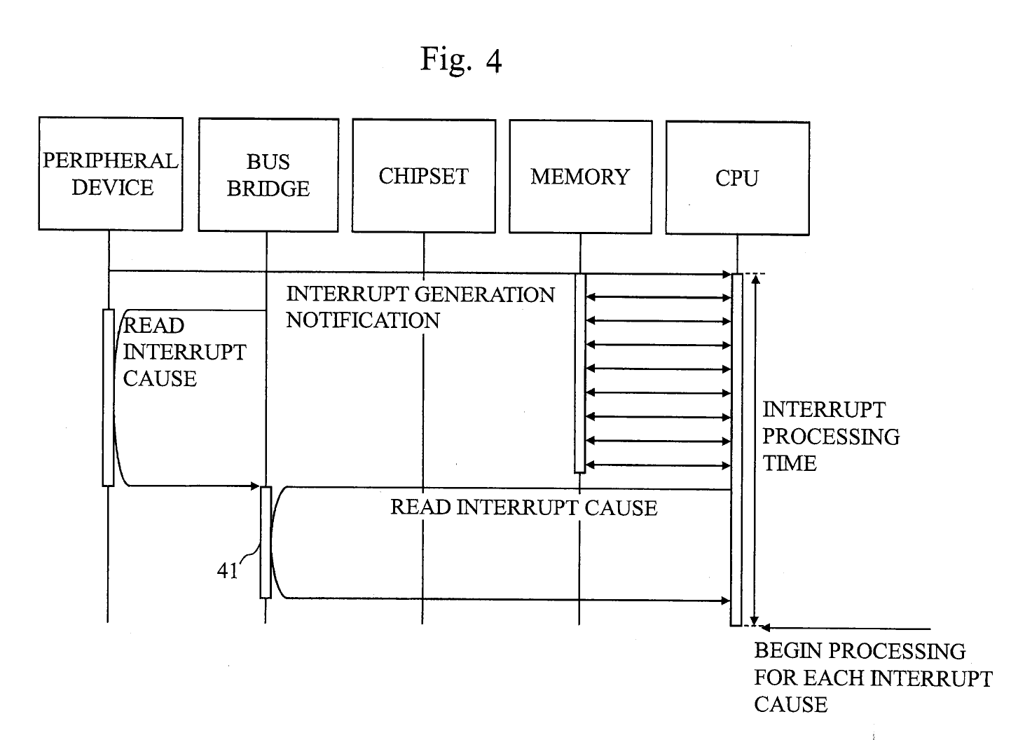

The total time of write time 31 for the bus bridge 2 to write the interrupt cause to the memory 5 and read time 32 for the CPU 4 to read the interrupt cause from the memory 5 is substantially shorter than read time 41 for the CPU of FIG. 4 to read the interrupt cause from the bus bridge.

As described above, the CPU 4 reads the interrupt cause from the memory 5 to which the CPU 4 can access fast. As a result, the interrupt processing time up to commencement of the interrupt processing can be reduced.

Moreover, no modification is required in circuits except for the bus bridge, so that development costs can be kept low.

In this embodiment, the bus bridge that receives an interrupt generation notification and transfers an interrupt cause to the memory has been described, and the interrupt processing system including the bus bridge has been described.

### LIST OF REFERENCE SIGNS

1: peripheral device, 2: bus bridge, 3: chipset, 4: CPU, 5: memory device, 21: interrupt cause transfer circuit, 22: bus conversion circuit, 23: bus interface circuit, 24: bus interface circuit

1-4. (canceled)

5. An interrupt cause management device comprising:
an interrupt generation notification receiving unit that receives an interrupt generation notification sent from a device;
an interrupt cause reading unit that, when the interrupt generation notification is received by the interrupt generation notification receiving unit, reads an interrupt cause from the device that has sent the interrupt generation notification;
an interrupt cause writing unit that writes the interrupt cause read by the interrupt cause reading unit to a memory device to be accessed by a processor device that processes the interrupt generation notification; and
an interrupt generation notification sending unit that sends to the processor device the interrupt generation notification received by the interrupt generation notification receiving unit,
wherein under a condition that an amount of read time required for the processor device to read the interrupt cause written in the memory device is shorter than an amount of time required for the processor device to read the interrupt cause from the device that has sent the interrupt generation notification,
the interrupt cause writing unit writes to the memory device the interrupt cause read by the interrupt cause reading unit before a timing when the processor device, upon receiving the interrupt generation notification sent from the interrupt generation notification sending unit, accesses the memory device to read the interrupt cause.

6. An interrupt processing system comprising:
a processor device connected to a predetermined memory device; and
a bus bridge connected to the processor device and the memory device,
wherein the bus bridge receives an interrupt generation notification sent from a device, sends to the processor device the interrupt generation notification that has been received, and under a condition that an amount of read time required for the processor device to read an interrupt cause written in the memory device is shorter than an amount of time required for the processor device to read the interrupt cause from the device that has sent the interrupt generation notification, reads the interrupt cause from the device that has sent the interrupt generation notification that has been received, and writes to the memory device the interrupt cause that has been read; and
wherein the processor device, upon receiving the interrupt generation notification sent from the bus bridge, reads the interrupt cause written to the memory device by the bus bridge.
